(19) United States
(12) Patent Application Publication
(10) Pub. No.: US 2026/0283162 A1
(43) Pub. Date: Sep. 24, 2026

(54) INDOLEACETIC ACID-ENRICHED ALGAE EXTRACT

(71) Applicant: FICOSTERRA, S.L., BURGOS (ES)

(72) Inventor: RAMON TERRADO MAÑAS, VALLDOREIX (ES)

(21) Appl. No.: 19/475,822

(22) PCT Filed: Apr. 18, 2024
(86) PCT No.: PCT/EP2024/060587

§ 371 Date: Oct. 16, 2025

(30) Foreign Application Priority Data
Apr. 19, 2023 (EP) 23382363.2

(51) Int. Cl. A01N 65/03; A01P 21/00; B01D 11/02

(52) U.S. Cl. CPC A01N 65/03; A01P 21/00; B01D 11/0288; B01D 11/0292

(57) ABSTRACT

An aqueous extract of the algae species Laminaria ochroleuca, wherein the extract includes indoleacetic acid at a concentration of at least 10 ppm. The extract can be used as plant biostimulant, and in a plant biostimulant composition. A method for improving plant growth and productivity can be achieved by applying the extract or the plant biostimulant composition.

This application claims the benefit of European Patent Application EP23382363.2 filed on Apr. 19, 2023.

### TECHNICAL FIELD

The present invention belongs to the field of plant biostimulants. In particular, the invention relates to natural biostimulants based on algae extracts highly enriched in plant growth regulators and processes for their production.

### BACKGROUND ART

The global population and the corresponding food demand have been increasing annually in the past decades, and improvements in crop production are therefore needed.

The use of plant biostimulants has contributed to enhanced crop yields in the agricultural fields. However, some of the synthetic biostimulants used have been found to cause negative environmental effects, such as eutrophication and ground water pollution. Accordingly, new regulations are limiting or even banning the use of chemically produced compounds for increasing crop yields.

Indoleacetic acid (indole-3-acetic acid or IAA) is the most common auxin-class phytohormone and plays vital roles in plant growth and plant development processes, such as cell division, cell expansion, cell differentiation and fruit development. Accordingly, indoleacetic acid has been added to biostimulant compositions to increase crop production. However, most of the indoleacetic acid commonly used in agriculture is synthesized by chemical methods. The alternative natural indoleacetic acid-containing products often have low indoleacetic acid concentrations or limited stability, which has hindered their application in large scale settings.

Thus, a need remains for natural plant biostimulants highly enriched in indoleacetic acid than can replace chemically synthesized biostimulants.

### SUMMARY OF INVENTION

The present inventors have found that aqueous extracts of the algae Laminaria ochroleuca present exceptionally high levels of indoleacetic acid, and that these levels are very stable over time. These characteristics make these extracts particularly useful as biostimulants for promoting plant growth and productivity.

As shown in the examples below, aqueous extracts of the algae Laminaria ochroleuca present indoleacetic acid at concentrations up to 17 ppm, several times higher than other extracts from different sources. Importantly, the present inventors found that the indoleacetic acid within the aqueous extracts of Laminaria ochroleuca is stable over several months without the need of any particular treatment or additives. Furthermore, the present inventors devised a simple and efficient method for producing the indoleacetic acid-enriched extracts by using a particular type of organic solvents. Thus, the extracts of the invention constitute a clear environmentally-friendly alternative to biostimulants containing chemically synthesized indoleacetic acid.

Thus, in a first aspect, the invention provides an aqueous extract of the algae species Laminaria ochroleuca, wherein the extract comprises indoleacetic acid at a concentration of at least 10 ppm, and particularly wherein the extract is obtainable by a process comprising the steps of (a) providing algae material from Laminaria ochroleuca having a moisture content of at least 10% w/w; (b) contacting the algae material with a partially water-miscible organic solvent at a temperature equal to or lower than 40° C.; (c) separating the partially water-miscible organic solvent contacted with the algae material in step (b); (d) evaporating the partially water-miscible organic solvent separated in step (c), thereby obtaining the aqueous extract.

In a second aspect, the invention provides the use of an extract as defined in the first aspect as plant biostimulant.

In a third aspect, the invention provides a plant biostimulant composition comprising an extract according to the first aspect.

In a fourth aspect, the invention provides a method for increasing plant growth and/or plant productivity, the method comprising applying to a plant or soil the extract as defined in the first aspect or the plant biostimulant composition as defined in the third aspect.

In a fifth aspect, the invention provides a process for the production of an aqueous extract of the algae species Laminaria ochroleuca, the process comprising the steps:
(a) providing algae material from Laminaria ochroleuca having a moisture content of at least 10% w/w; (b) contacting the algae material with a partially water-miscible organic solvent at a temperature equal to or lower than 40° C.; (c) separating the partially water-miscible organic solvent contacted with the algae material in step (b); (d) evaporating the partially water-miscible organic solvent separated in step (c), thereby obtaining the aqueous extract.

In a sixth aspect, the invention provides an extract of the algae species Laminaria ochroleuca obtainable by the process of the fifth aspect.

### DETAILED DESCRIPTION OF THE INVENTION

All terms as used herein in this application, unless otherwise stated, shall be understood in their ordinary meaning as known in the art. Other more specific definitions for certain terms as used in the present application are as set forth below and are intended to apply uniformly through-out the specification and claims unless an otherwise expressly set out definition provides a broader definition.

As used herein, the indefinite articles “a” and “an” are synonymous with “at least one” or “one or more.” Unless indicated otherwise, definite articles used herein, such as “the” also include the plural of the noun.

For purposes of the present invention, any ranges given include both the lower and the upper end-points of the range. Ranges given, such as concentrations and the like, should be considered approximate, unless specifically stated. As used herein, the term “about” refers to a range of values that is 15% more or less than a fixed value.

As used herein, “extract” or “algae extract” refers to a concentrated preparation of one or various parts of an algae obtained by isolating the active constituents, particularly indoleacetic acid, by solvent extraction. The terms “algae” and “seaweed” are used interchangeably herein. As used herein, an “aqueous extract” refers to an extract where the active constituents are dissolved in water, that is, an extract where water is the final solvent. The preparation of an aqueous extract may involve the use of extraction solvents different from water, in particular organic solvents, provided that these non-water solvents are subsequently removed and are not the main solvent in the final extract.

As used herein, “moisture content” or “water content” refers to the percentage ratio of the weight of free water present in the algae material to the total weight of the algae material. For instance, a 50% w/w moisture content means that an algae material of 100 g contains 50 g of water. There are several techniques known by the skilled in the art which can be used to measure the moisture content of algae materials.

The term “algae material from Laminaria ochroleuca” as used herein refers to any part of the algae Laminaria ochroleuca. Laminaria ochroleuca is a seaweed that belongs to the order Laminariales and family Laminariaceae. It is commonly known as golden kelp, due to their blade coloration, and can be found in the Northern Hemisphere.

As used herein, “weight/volume ratio” refers to the relation of the weight of one component to the volume of another component. In particular, it refers to the weight of algae material (in kg) to the volume of organic solvent (in liters). For example, a weight/volume ratio (algae material:organic solvent) of 1:1 refers to 1 kg of algae material for every 1 liter of organic solvent.

“Solvent extraction”, as used herein, refers to the separation of materials of different chemical types and solubilities by selective solvent action. Some materials are separated more easily in one solvent than by another, hence there is a preferential extractive action. “Organic extraction” or “organic solvent extraction”, for purposes of the present invention, refers to the “solvent extraction” described above, wherein said solvent is an organic solvent. “Partially water-miscible organic solvent” refers to an organic solvent that is only partially soluble in water. Preferably, it refers to an organic solvent with solubility in water at 20° C. from 2 g/100 ml to 30 g/100 ml.

As used herein, “plant biostimulant” refers to a composition capable of improving plant growth and/or plant productivity. As is employed herein, the term “effective amount” refers to an amount of a composition, particularly of the extract of the invention, which will increase the growth and or vigor of the plant to an extent exceeding that of identical plants not treated with the composition.

As above indicated, the present invention provides an aqueous extract of the algae species Laminaria ochroleuca, wherein the extract comprises indoleacetic acid at a concentration of at least 10 ppm, and particularly wherein the extract is obtainable by a process comprising the steps of (a) providing algae material from Laminaria ochroleuca having a moisture content of at least 10% w/w; (b) contacting the algae material with a partially water-miscible organic solvent at a temperature equal to or lower than 40° C.; (c) separating the partially water-miscible organic solvent contacted with the algae material in step (b); (d) evaporating the partially water-miscible organic solvent separated in step (c), thereby obtaining the aqueous extract. The term “indoleacetic acid”, “indole-3-acetic acid” and “IAA” are used interchangeably and refer to the molecule with CAS number 87-51-4.

In a particular embodiment of the first aspect, the extract comprises indoleacetic acid at a concentration of at least 11 ppm, at least 12 ppm, at least 13 ppm, at least 14 ppm, at least 15 ppm, at least 16 ppm, or at least 17 ppm. In a more particular embodiment, the indoleacetic acid—in the extract is at a concentration of about 17 ppm.

In a particular embodiment of the first aspect, the extract is stable for at least 6 months, at least 12 months, at least 13 months, at least 14 months, at least 15 months, at least 16 months, at least 18 months, at least 20 months, at least 22 months, at least 24 months, at least 30 months, at least 36 months, or at least 40 months. In a more particular embodiment, the extract is stable for at least 12 months. As used herein, “stable extract” refers to extracts that retain a specified concentration of the active components, in particular indoleacetic acid, over a given period of time, particularly when stored at a temperature from 15° C. to 25° C.

In a particular embodiment of the first aspect, the indoleacetic levels in the extract are stable for at least 6 months, at least 12 months, at least 13 months, at least 14 months, at least 15 months, at least 16 months, at least 18 months, at least 20 months, at least 22 months, at least 24 months, at least 30 months, at least 36 months, or at least 40 months; particularly when stored at a temperature from 15° C. to 25° C.

In a particular embodiment of the first aspect, the extract further comprises trans-zeatin riboside. The term “trans-zeatin riboside” and “zeatin riboside” are used interchangeably and refer to the molecule with CAS number 6025-53-2.

In a particular embodiment of the first aspect, the trans-zeatin riboside in the extract is at a concentration of at least 1 ppm, at least 2 ppm, at least 3 ppm, at least 4 ppm, or of at least 5 ppm. In a more particular embodiment, the trans-zeatin riboside in the extract is at a concentration of about 5 ppm.

In an embodiment of the first aspect, the extract further comprises salicylic acid. In a more particular embodiment, the salicylic acid in the extract is at a concentration of at least 1 ppm, at least 2 ppm, or at least 3 ppm. In a more particular embodiment, the salicylic acid in the extract is at a concentration of from 1 ppm to 3 ppm; more particularly of about 3 ppm.

In another embodiment of the first aspect, the extract comprises indoleacetic acid, trans-zeatin riboside, and salicylic acid. In a more particular embodiment, the extract comprises at least 10 ppm of indoleacetic acid, at least 1 ppm of trans-zeatin riboside, and at least 1 ppm of salicylic acid. In an even more particular embodiment, the extract comprises about 17 ppm of indoleacetic acid, about 5 ppm of trans-zeatin riboside, and about 3 ppm of salicylic acid.

In a particular embodiment of the first aspect, the extract further comprises mannitol and/or alginic acid.

In another embodiment of the first aspect, the extract comprises indoleacetic acid, trans-zeatin riboside, salicylic acid, mannitol and alginic acid. In a more particular embodiment, the extract comprises at least 5 ppm of indoleacetic acid, at least 1 ppm of trans-zeatin riboside, at least 1 ppm of salicylic acid, at least 50 ppm of mannitol, and at least 100 ppm of alginic acid. In an even more particular embodiment, the extract comprises about 17 ppm of indoleacetic acid, about 5 ppm of trans-zeatin riboside, about 3 ppm of salicylic acid, about 300 ppm of mannitol, and about 300 ppm of alginic acid.

In a particular embodiment of the first aspect, the extract comprises indoleacetic acid and trans-zeatin riboside in a weight ratio from 2.1:1 to 4.9:1, from 2.2:1 to 4.8:1, from 2.3:1 to 4.7:1, from 2.4:1 to 4.6:1, from 2.5:1 to 4.5:1, from 2.6:1 to 4.4:1, from 2.7:1 to 4.3:1, from 2.8:1 to 4.2:1, from 2.9:1 to 4.1:1, from 3:1 to 4:1, from 3.1:1 to 3.9:1, from 3.2:1 to 3.8:1, from 3.3:1 to 3.7:1, or from 3.4:1 to 3.6:1. In a more particular embodiment, the weight ratio of indoleacetic acid to trans-zeatin riboside is of about 3.4:1.

In a particular embodiment of the first aspect, the extract comprises indoleacetic acid, trans-zeatin riboside, and salicylic acid in a weight ratio (indoleacetic acid:trans-zeatin riboside; and salicylic acid) is from 2:1:0.1 to 5:1:2. In a more particular embodiment, the weight ratio of indoleacetic acid, trans-zeatin riboside, and salicylic acid in the extract is from 2:1:0.1 to 5:1:2, from 2.3:1:0.3 to 4.7:1:1.5, from 2.7:1:0.4 to 4.3:1:1, from 3:1:0.5 to 4:1:0.7. In a more particular embodiment, the weight ratio of indoleacetic acid, trans-zeatin riboside, and salicylic acid in the extract is of about 3.4:1:0.6.

In another embodiment of the first aspect, the extract further comprises a soft acid, such as acetic acid. The soft acid may improve the stability of the indoleacetic acid in the extract.

In a particular embodiment of the first aspect, the extract has a pH from 2 to 7, from 3 to 6, or from 3.8 to 5.7. Particularly, the extract has a pH from 3.8 to 5.7.

In a particular embodiment of the first aspect, the extract is a liquid extract. In another particular embodiment, the solvent of the extract is water.

In a particular embodiment of the first aspect, the extract is obtainable by organic solvent extraction with a partially water-miscible organic solvent.

In a particular embodiment of the first aspect, the extract is obtainable by organic solvent extraction with a partially water-miscible organic solvent followed by evaporation of the partially water-miscible organic solvent.

In a particular embodiment of the first aspect, the extract is obtainable by a process comprising the steps of (a) providing algae material from Laminaria ochroleuca having a moisture content of at least 10% w/w; (b) contacting the algae material with a partially water-miscible organic solvent at a temperature equal to or lower than 40° C.; (c) separating the partially water-miscible organic solvent contacted with the algae material in step (b); (d) evaporating the partially water-miscible organic solvent separated in step (c), thereby obtaining the aqueous extract.

When the partially water-miscible organic solvent is contacted with the algae material in step (b), several active compounds (including IAA) and some of the water contained in the algae material is dissolved in the partially water-miscible organic solvent. Thus, when the contacted partially water-miscible organic solvent is separated and evaporated in steps (c) and (d), a water fraction—formed by the water and the water-soluble compounds from the algae material that were dissolved in the organic solvent and/or the water—and a precipitate fraction—formed by the non-water soluble compounds from the algae material that were dissolved in the organic solvent—are generated. The water fraction is the aqueous extract of the invention.

In a particular embodiment of the first aspect, the extract is obtainable by a process comprising the steps of (a) providing algae material from Laminaria ochroleuca having a moisture content of at least 10% w/w; (b) contacting the algae material with a partially water-miscible organic solvent at a temperature equal to or lower than 40° C., wherein the indoleacetic acid and part of the water of the algae material are dissolved in the partially water-miscible organic solvent; (c) separating the partially water-miscible organic solvent contacted with the algae material in step (b); (d) evaporating the partially water-miscible organic solvent separated in step (c), thereby obtaining the aqueous extract.

In a particular embodiment of the first aspect, the partially water-miscible organic solvent has a boiling point lower than the boiling point of water.

In a particular embodiment of the first aspect, the moisture content of the algae material provided in step (a) is of at least 10% w/w, of at least 15% w/w, of at least 20% w/w, of at least 25% w/w, or of at least 30% w/w. In a more particular embodiment, the moisture content of the algae material provided in step (a) is from 10% w/w to 99% w/w, from 15% w/w to 40% w/w, from 20% w/w to 45% w/w, or from 20% w/w to 30% w/w.

In a particular embodiment of the first aspect, the algae material is fresh algae material. As used herein, “fresh algae material” refers to algae material that maintains substantially the same moisture content that it had in vivo state.

In a particular embodiment of the first aspect, in step (b) the algae material is contacted with the partially water-miscible organic solvent at a weight/volume ratio from 1:1 to 1:10, from 1:2 to 1:9, from 1:3 to 1:8, from 1:4 to 1:7, or from 1:5 to 1:6. In a more particular embodiment, the algae material is contacted with the partially water-miscible organic solvent at a weight/volume ratio from 1:2 to 1:6.

In an embodiment of the first aspect, the step (b) comprises mixing the algae material with a partially water-miscible organic solvent at a temperature equal to or lower than 40° C.

In an embodiment of the first aspect, the partially water-miscible organic solvent has a solubility in water at 20° C. from 2 g/100 ml to 50 g/100 ml, form 5 g/100 ml to 40 g/100 ml, from 10 g/100 ml to 30 g/100 ml; particularly from 2 g/100 ml to 30 g/100 ml.

In an embodiment of the first aspect, the organic solvent is selected from dimethoxymethane, diethyl ether, and mixtures thereof.

In another embodiment of the first aspect, the step (b) is carried out in the dark. In a more particular embodiment, the step (b) and any subsequent steps are carried out in the dark.

In a particular embodiment of the first aspect, the step (b) is carried out at a temperature equal to or lower than 39° C., equal to or lower than 38° C., equal to or lower than 37° C., equal to or lower than 36° C., equal to or lower than 35° C., equal to or lower than 34° C., equal to or lower than 33° C., equal to or lower than 32° C., equal to or lower than 31° C., or equal to or lower than 30° C. In a more particular embodiment, the step (b) is carried out at a temperature from 10° C. to 50° C., from 20° C. to 40° C., from 25° C. to 35° C., or of about 30° C.

In a particular embodiment of the first aspect, the step (b) is carried out for a period of time of at least 0.5 h, of at least 1 h, of at least 1.5 h, of at least 2 h, of at least 2.5 h, or of at least 3 h. In a more particular embodiment, the step (b) is carried out for a period of time from 1 h to 5 h, from 2 h to 4 h, or for about 3 hours.

In an embodiment of the first aspect, the step (b) is carried out until the indoleacetic acid contained in the algae material from Laminaria ochroleuca is completely dissolved in the partially water-miscible organic solvent.

In a particular embodiment of the first aspect, when the algae material comprises gas vesicles, the method further comprises, after step (a) and before step (b), the step (a′) breaking the gas vesicles of the algae material. Breaking the gas vesicles avoids solvent retention during step (c) and allows obtaining extracts of better quality.

In an embodiment of the first aspect, the method further comprises after step (a) and before step (b), the step (a″) cutting the algae material, particularly into fragments of length from 0.5 cm to 10 cm, from 1 cm to 9 cm, from 2 cm to 8 cm, from 3 cm to 7 cm, from 4 cm to 6 cm, or from 5 cm to 6 cm. In a more particular embodiment, the algae material is cut into fragments of length from 1 cm to 5 cm. This cutting step can be carried out with any standard technique known by the skilled in the art.

In a particular embodiment of the first aspect, the step (b) is carried out at a pressure from 50 KPa to 1000 KPa, from 100 KPa to 900 KPa, from 200 KPa to 800 KPa, from 300 KPa to 700 KPa, or from 400 KPa to 600 KPa. More particularly, the step (b) is carried out at a pressure from 100 KPa to 800 KPa.

In a particular embodiment of the first aspect, the step (b) further comprises agitating o applying ultrasounds to the algae material. By applying agitation or ultrasounds during the organic solvent extraction the yield of the extraction may be improved.

The separation and evaporation of the partially water-miscible organic solvent in steps (c) and (d), respectively, can be carried out by any routine methods known to the skilled in the art.

In a particular embodiment of the first aspect, the process further comprises a pre-drying step before step (b) wherein the moisture content of the algae material is reduced to a value equal to or lower than 90% w/w, 80% w/w, 70% w/w, 60% w/w, 50% w/w, 40% w/w, or 30% w/w. In a more particular embodiment, the moisture content of the algae material is reduced to a value from 30% w/w to 40% w/w.

In a particular embodiment of the first aspect, the process is a batch process or a semi-continuous process.

In a particular embodiment of the first aspect, the process further comprises, after step (d), the step (e) concentrating and/or filtering the aqueous extract.

In a particular embodiment of the first aspect, the process further comprises, after step (d), the step (d′) adjusting the pH of the aqueous extract, particularly by adding a soft acid, such as acetic acid.

In a further aspect, the invention provides an aqueous extract of an algae from the Laminariaceae family or the Laminaria genus, wherein the extract comprises indoleacetic acid at a concentration of at least 10 ppm.

As above indicated, the invention also provides in a second aspect the use of the extract of the invention as plant biostimulant.

The invention also provides in a third aspect a plant biostimulant composition comprising the extract of the invention.

In a particular embodiment of the third aspect, the plant biostimulant composition comprises an effective amount of the extract of the invention. In a more particular embodiment, the plant biostimulant composition further comprises suitable excipients and/or carriers.

As above described, the invention provides in a fourth aspect a method for increasing plant growth and/or plant productivity, the method comprising applying to a plant or soil the extract or the plant biostimulant composition of the invention.

All embodiments disclosed above for the extract of the first aspect are also meant to apply to the use of the extract of the second aspect, the plant biostimulant composition of the third aspect, and the method for increasing plant growth and/or plant productivity of the fourth aspect.

As above explained, in a fifth aspect the invention provides a process for producing an extract of the algae species Laminaria ochroleuca. All the embodiments disclosed above for the extract of the first aspect, in particular the embodiments related to the production process, are also meant to apply to this fifth aspect.

As above disclosed, in a sixth aspect the invention provides an extract of the algae species Laminaria ochroleuca obtainable by a process as defined in the first aspect.

The extract “obtainable by” the process as defined above is used herein to define the extract by its preparation process and relates to the extract obtainable by the process which comprises at least the steps a), b), and c) described above. For the purposes of the invention, the expressions “obtainable”, “obtained” and equivalent expressions are interchangeably used, and in any case the expression “obtainable” includes the expression “obtained”.

All the embodiments above described for the extract of the first aspect are also meant to apply to the extract of the sixth aspect.

Throughout the description and claims the word “comprise” and variations of the word, are not intended to exclude other technical features, additives, components, or steps. Furthermore, the word “comprise” encompasses the case of “consisting of”. Additional objects, advantages and features of the invention will become apparent to those skilled in the art upon examination of the description or may be learned by practice of the invention. The following examples are provided by way of illustration, and they are not intended to be limiting of the present invention. Furthermore, the present invention covers all possible combinations of particular and preferred embodiments described herein.

For reasons of completeness, various aspects of the invention are set out in the following numbered clauses:

1. An aqueous extract of the algae species Laminaria ochroleuca, wherein the extract comprises indoleacetic acid at a concentration of at least 10 ppm.
2. The extract according to clause 1, wherein the extract comprises indoleacetic acid at a concentration of at least 17 ppm.
3. The extract according to any one of clauses 1-2, wherein the extract is stable for at least 12 months at a temperature from 15° C. to 25° C.
4. The extract according to any one of clauses 1-3, wherein the extract further comprises trans-zeatin riboside; particularly at a concentration of at least 3 ppm.
5. The extract according to any one of clauses 1-4, wherein the extract further comprises salicylic acid; particularly at a concentration of at least 1 ppm.
6. The extract according to any one of clauses 1-5, which is obtainable by a process comprising the steps of:
(a) providing algae material from Laminaria ochroleuca having a moisture content of at least 10% w/w;
(b) contacting the algae material with a partially water-miscible organic solvent at a temperature equal to or lower than 40° C.;
(c) separating the partially water-miscible organic solvent contacted with the algae material in step (b);
(d) evaporating the partially water-miscible organic solvent separated in step (c), thereby obtaining the aqueous extract.
   7. The extract according to clause 6, wherein the moisture content of the algae material provided in step (a) is from 15% w/w to 50% w/w; particularly from 20% w/w to 30% w/w.
   8. The extract according to any one of clauses 6-7, wherein in step (b) the algae material is contacted with the partially water-miscible organic solvent at a weight/volume ratio from 1:1 to 1:10; particularly from 1:2 to 1:6.
   9. The extract according to any one of clauses 6-8, wherein the partially water-miscible organic solvent has a solubility in water at 20° C. from 2 g/100 ml to 30 g/100 ml.
   10. The extract according to any one of clauses 6-9, wherein the partially water-miscible organic solvent is dimethoxymethane.
   11. The extract according to any one of clauses 6-10, wherein step (b), and optionally any subsequent step, is carried out in the dark.
   12. A process for the production of an aqueous extract of the algae species Laminaria ochroleuca, the process comprising the steps:
(a) providing algae material from Laminaria ochroleuca having a moisture content of at least 10% w/w;
(b) contacting the algae material with a partially water-miscible organic solvent at a temperature equal to or lower than 40° C.;
(c) separating the partially water-miscible organic solvent contacted with the algae material in step (b);
(d) evaporating the partially water-miscible organic solvent separated in step (c), thereby obtaining the aqueous extract.
   13. Use of the extract as defined in any one of clauses 1-11 as plant biostimulant.
   14. A plant biostimulant composition comprising the extract according to any one of clauses 1-11.
   15. A method for increasing plant growth and/or plant productivity, the method comprising applying to a plant or soil the extract as defined in any of clauses 1-11, or the plant biostimulant composition as defined in clause 14.

### EXAMPLES

### Substrate and Solvent

Laminaria ochroleuca biomass with a humidity ranging 20-30% was used for the preparation of the extracts. The biomass was chopped to fragments ranging 1-5 cm long prior to the extraction to facilitate exchange with the solvent within the reactor. The seaweed gas vesicles were broken during the chopping process to avoid retention of solvent once the extraction was finished.

The organic solvent used was dimethoxymethane, a partially water-miscible colorless flammable liquid with low boiling point and low viscosity. Dimethoxymethane can be evaporated by heating at 42° C. at atmospheric pressure or by vacuum at room temperature. Liquefied dimethoxymethane has the capacity to dissolve most oils and also about 6 wt % of water at 20° C.

### Extraction Conditions

Ratios of substrate to organic solvent tested ranged from 2 liters of dimethoxymethane per 1 kg of seaweed to 6 liters of dimethoxymethane per 1 kg seaweed. The extraction was done at sub-critical conditions, at pressures ranging 100-800 KPa. The process was done in the dark and at temperatures around 30° C. which reduced auxin degradation. Exchange with solvent was facilitated by movement of the reactor or by applying ultrasounds.

### Indoleacetic Acid Analysis

To measure the concentration of indoleacetic acid (IAA) in the extracts, these were first centrifuged and filtered through a 0.22 μm membrane and then analyzed by ultraperformance liquid chromatography coupled with a photodiode-array detector and electrospray ionization quadrupole time-of-flight mass spectrometry (UPLC-ESI-QToF-MS) using standard procedures.

### Batch Process

The simplest process used to produce the extracts consisted of a system with a reactor where the chopped Laminaria ochroleuca biomass was introduced. This reactor was closed and subjected to vacuum as a security measure, to avoid explosion reactions by mixture of dimethoxymethane and oxygen. Once vacuum was done, dimethoxymethane was introduced at pressure within the reactor and was allowed to dissolve cellular membranes (lipids) and penetrate within the biomass, dissolving water and other molecules. In the batch process, extraction time could last up to several hours, but if the dimethoxymethane was heated (but <30° C.) and the reactor was moved it facilitated exchange and saturation of dimethoxymethane was achieved faster. Optimal results were obtained with extraction times of 3 hours at 30° C.

Once the extraction was finished, dimethoxymethane was emptied from the reactor within a deposit. Dimethoxymethane dragged with it up to 6 wt % of water and other molecules of the algae, including the IAA. Within this deposit, vacuum was applied to evaporate the dimethoxymethane. Water and other molecules, including the IAA, accumulated in the deposit while dimethoxymethane was removed by simply evaporating to the atmosphere.

The resulting aqueous extract contained IAA at concentrations around 17 ppm, which appeared to be its solubility limit in water. These levels are several times higher than those obtained from other vegetable sources. Occasionally, an IAA precipitated was formed, which was readily dissolved adding additional water, or other solvents such as acetone. Alternatively, basic solutions were found to help increasing the solubility of IAA in water in order to increase its recovery in aqueous solution.

Other active molecules detected in the extracts were trans-zeatin riboside (up to 5 ppm), salicylic acid (1-3 ppm), mannitol (65-300 ppm) and alginic acid (300 ppm). The pH of the extract ranged from 3.8 to 5.7.

The stability of the extracts was analyzed up to 12 months by periodically measuring the concentration of the active molecules. It was found that the concentration of the active molecules in the extracts, particularly IAA, remained unaltered during at least 12 months, which demonstrates that the extracts of the invention not only have very high levels of IAA, but also that these levels are very stable, making them highly suitable for agricultural applications.

### Semi-Continuous Process

Extracts were also prepared following a more complex semi-continuous process where a vertical digestor was filled with chopped Laminaria ochroleuca biomass and vacuum was performed. This vertical digestor was equipped with ultrasounds to facilitate exchange between substrate and solvent. A reservoir fed dimethoxymethane to the digestor from bottom to the top. Both the top and the bottom of the digestor were equipped with 10 μm filters. The liquid dimethoxymethane coming out from the top of the digestor dragged water and other molecules, including IAA. This liquid was then fed to an evaporator that was maintained at 40-45° C. This evaporator was hold at maximum pressure of 300 kPa in order to recover the dimethoxymethane as a gas phase. This was then directed to a dry compressor with the purpose to be condensate in a heat-exchanger. This condensed dimethoxymethane was then sent to the dimethoxymethane reservoir to be re-used. The liquid phase within the evaporator was sent to a second evaporator maintained at 50 kPa and 45° C. to finish the recovery of any remaining dimethoxymethane within the extract. The gas-phase coming out of this second evaporator was sent using a compressor to the gas-phase of the first evaporator and finally to the compressor for recovery in the reservoir.

The liquid extracted out of the second evaporator was sent to a stripping tank at 10 kPa to remove any dimethoxymethane left by bubbling nitrogen. The liquid out of this stripping tank was the indoleacetic-enriched extract which contained around 17 ppm of IAA.

What is claimed is:

1. An aqueous extract of the algae species Laminaria ochroleuca, wherein the extract comprises indoleacetic acid at a concentration of at least 10 ppm, and wherein the extract is obtainable by a process comprising the steps of:
(a) providing algae material from Laminaria ochroleuca having a moisture content of at least 10% w/w;
(b) contacting the algae material with a partially water-miscible organic solvent at a temperature equal to or lower than 40° C.;
(c) separating the partially water-miscible organic solvent contacted with the algae material in step (b);
(d) evaporating the partially water-miscible organic solvent separated in step (c), thereby obtaining the aqueous extract.

2. The extract according to claim 1, wherein the extract comprises indoleacetic acid at a concentration of at least 17 ppm.

3. The extract according to claim 1, wherein the extract is stable for at least 12 months at a temperature from 15° C. to 25° C.

4. The extract according to claim 1, wherein the extract further comprises trans-zeatin riboside.

5. The extract according to claim 1, wherein the extract further comprises salicylic acid.

6. The extract according to claim 1, wherein the moisture content of the algae material provided in step (a) is from 15% w/w to 50% w/w.

7. The extract according to claim 1, wherein in step (b) the algae material is contacted with the partially water-miscible organic solvent at a weight/volume ratio from 1:1 to 1:10.

8. The extract according to claim 1, wherein the partially water-miscible organic solvent has a solubility in water at 20° C. from 2 g/100 ml to 30 g/100 ml.

9. The extract according to claim 1, wherein the partially water-miscible organic solvent is dimethoxymethane.

10. The extract according to claim 1, wherein step (b) is carried out in the dark.

11. The extract according to claim 1, wherein the extract is stable for at least 6 months.

12. The extract according to claim 1, wherein the indoleacetic levels in the extract are stable for at least 6 months.

13. A process for the production of an aqueous extract of the algae species Laminaria ochroleuca, the process comprising the steps:
(a) providing algae material from Laminaria ochroleuca having a moisture content of at least 10% w/w;
(b) contacting the algae material with a partially water-miscible organic solvent at a temperature equal to or lower than 40° C.;
(c) separating the partially water-miscible organic solvent contacted with the algae material in step (b);
(d) evaporating the partially water-miscible organic solvent separated in step (c), thereby obtaining the aqueous extract.

14. (canceled)

15. A plant biostimulant composition comprising the extract according to claim 1.

16. A method for increasing plant growth and/or plant productivity, the method comprising applying to a plant or soil the plant biostimulant composition as defined in claim 15.

17. The extract according to claim 1, wherein the extract further comprises trans-zeatin riboside at a concentration of at least 3 ppm.

18. The extract according to claim 1, wherein the extract further comprises salicylic acid at a concentration of at least 1 ppm.

19. The extract according to claim 1, wherein the moisture content of the algae material provided in step (a) is from 20% w/w to 30% w/w.

20. The extract according to claim 1, wherein in step (b) the algae material is contacted with the partially water-miscible organic solvent at a weight/volume ratio from 1:2 to 1:6.

21. The extract according to claim 1, wherein the indoleacetic levels in the extract are stable for at least 6 months when stored at a temperature from 15° C. to 25° C.
